(19) United States
(12) Patent Application Publication
(10) Pub. No.: US 2015/0023778 A1
(43) Pub. Date: Jan. 22, 2015

(54) MICRO GAS TURBINE SYSTEM WITH A PIPE-SHAPED RECUPERATOR

(71) Applicant: Babcock Borsig Steinmuller GmbH, Oberhausen (DE)

(72) Inventors: Peter Berg, Cottbus (DE); Frieder Neumann, Berlin (DE); Mathias Born, Berlin (DE); Karl-Friedrich Schroder, Grunstadt (DE)

(73) Assignee: BABCOCK BORSIG STEINMULLER GMBH, Oberhausen (DE)

(21) Appl. No.: 14/380,166

(22) PCT Filed: Feb. 19, 2013
(86) PCT No.: PCT/EP2013/000481

§ 371 Date: Aug. 21, 2014

(30) Foreign Application Priority Data
Feb. 21, 2012 (DE) 102012003347.8
Feb. 21, 2012 (DE) 102012003348.6

(51) Int. Cl. F02C 3/05

(52) U.S. Cl. CPC F02C 3/05
USPC 415/116

(57) ABSTRACT

A micro gas turbine system (1) having an annular recuperator (9) for heat transfer from an exhaust gas flow (13) to an intake air flow (8). The exhaust gas flow (13) flows through radial inlets (18) into the recuperator (9) and/or out of the recuperator (9) through radial outlets (19).

### BACKGROUND

The invention relates to a micro-gas turbine plant with an annular recuperator for heat transfer from an exhaust gas flow to an airflow.

Micro-gas turbine plants usually comprise the following components:

A generator for power generation,

A compressor for the combustion air,

A combustion chamber,

A turbine, and

An annular recuperator.

In this case, it concerns compact units, which in most cases are transportable. Micro-gas turbine plants are frequently only two to three meters long, one to two meters wide and one to two meters high.

Micro-gas turbine plants are used for a decentralized power supply, wherein the generated electric power is below 250 kW. The waste heat is frequently used for heating purposes, for example for heating buildings.

Micro-gas turbine plants are single-shaft machines in most cases, in which generator, compressor and turbine are arranged on one shaft.

In micro-gas turbine plants, air is inducted and compressed by the compressor. The air is preheated in the annular recuperator and fed to the combustion chamber. Burners, which combust a fuel gas with the preheated air, are arranged in the combustion chamber. The turbine of the micro-gas turbine plant is driven by the hot exhaust gases from the combustion chamber. The expanded exhaust gas flow is conducted out via the recuperator and heats the airflow.

A quite distinctive difference between compact, transportable micro-gas turbine plants and large power plants with immovably installed gas turbines is the use of an annular recuperator. The annular recuperator is usually of hollow cylindrical design and encloses some of the components.

Recuperators are heat exchangers, in which heat is transferred from a hotter fluid flow to a colder fluid flow which is spatially separated therefrom, wherein the two fluids are not intermixed. In recuperators of micro-gas turbine plants, the combustion air is preheated by the hot exhaust gases of the turbine.

In WO 02/39045 A2, a micro-gas turbine plant with an annular recuperator is described. The hot exhaust gas flow of the turbine flows into the recuperator via axial inlets and flows out of the recuperator via axial inlets on the opposite side. As a result of this type of exhaust gas guiding, potential for heat transfer is lost. This has a negative effect upon the efficiency of the micro-gas turbine plant. Moreover, the guiding of the exhaust gas flow calls for important constructional features of the micro-gas turbine plant. Described in WO 02/39045 A2 is a micro-gas turbine plant in which the recuperator is immovably installed in a housing and cannot be exchanged without greater cost.

### SUMMARY

It is the object of the invention to provide a micro-gas turbine plant with an annular recuperator, in which heat transfer between the exhaust gas flow and the airflow is optimized. This is to contribute to an increase of the efficiency. The individual components are to be easily accessible for maintenance operations. Moreover, the micro-gas turbine plant is to be easily installable and inexpensive to produce. A reliable operation is also to be ensured.

This object is achieved according to the invention by the exhaust gas flow flowing into the recuperator via radial inlets and/or flowing out of the recuperator via radial outlets.

The terms axial and radial are direction indications which relate to a rotational axis as a reference system. This rotational axis is formed by the shaft in the case of micro-gas turbine plants.

In a particularly advantageous embodiment of the invention, the exhaust gas flow flows into the recuperator via radial inlets and flows out of the recuperator via radial outlets.

In contrast to conventional micro-gas turbine plants, the inflow and outflow of the exhaust gas flow therefore takes place not via axial but via radial inlets and outlets. Created as a result is a construction in which the recuperator is easily accessible for maintenance operations since there are no obstructions by exhaust gas inlets and outlets at the axial ends of the recuperator. Moreover, the newly constructed micro-gas turbine plant can be easily installed and is therefore inexpensive to produce. As a result of this exhaust gas guiding, good heat transfer and higher efficiency of the micro-gas turbine plant are achieved.

The annular recuperator preferably has a hollow cylindrical geometry. It extends in the axial direction and encloses other components of the micro-gas turbine plant. It proves to be particularly advantageous if the recuperator at least partially encloses, but preferably completely encloses, the combustion chamber. In this case, it is specifically an annular combustion chamber.

The radial inlets and the radial outlets are preferably arranged on sides of the recuperator which are axially opposite each other. In this way, the exhaust gas flow first of all flows through the entire recuperator in the axial direction before it exits this again. As a result of the longer residence time, the exchange of heat between the two fluid flows is improved.

In a favorable embodiment of the invention, the recuperator has an inner and/or an outer casing surface. They are preferably closed cylindrical casing surfaces. In this case, it proves to be advantageous if these are formed of a metal or an alloy. The inner casing surface is preferably arranged in the outer casing surface in an axially centered manner.

In a variant of the invention, the inner casing surface and/or the outer casing surface have, or has, openings which form radial inlets and/or the radial outlets for the exhaust gas flow. In this case, slot-like and/or circular openings, for example, are introduced into the otherwise closed cylindrical casing surfaces, for example by punching, drilling or cutting in.

The inner casing surface and/or the outer casing surface are, or is, formed from a bent metal strip, preferably from a sheet metal strip, in a preferred variant of the invention. The cylindrical casing surfaces form an inner and outer band. The metal strip is bent to form a cylindrical casing surface which encloses a cylindrical space. At the edges, at which the bent metal strip comes together, this is preferably welded together.

Radial inlet openings and/or radial outlet openings for the exhaust gas flow can be introduced in the metal strips. The openings are preferably punched in. The production of such an inner and outer casing surface is particularly inexpensive. Such casing surfaces, which are formed from metal bands, are distinguished by a low weight.

An annular combustion chamber is preferably arranged in the cylindrical space which is enclosed by the inner casing surface. A flow chamber for the exhaust gases, which exit the turbine, preferably extends axially centrally in this cylindrical space.

In a particularly advantageous embodiment of the invention, the inner casing surface extends over the entire length of the recuperator. Openings, which form radial inlets for the exhaust gas flow of the turbine, are introduced into the casing surface. The openings can be cut in, for example. Alternatively, the openings can be punched in, wherein this method is especially suitable when producing the casing surface from a metal strip.

In a particularly advantageous variant, the outer casing surface extends in the axial direction only as far as an exhaust gas collector. As a result, no outlet openings have to be introduced for the exhaust gas flow, rather the exhaust gas, after flowing through the recuperator, makes its way into the annular exhaust gas collector which encloses the recuperator.

The inner casing surface and/or the outer casing surface can also be formed from a tube with a slightly larger wall thickness, wherein the inner tube is preferably arranged in the outer tube in an axially centered manner.

Openings, which form the radial inlets for the exhaust gas flow, are preferably introduced in the inner tube. The openings can especially be formed as slots. Openings, which form the radial outlets for the exhaust gas flow, can also be introduced in the outer tube. These openings are preferably also formed as slots.

It proves to be favorable if the two fluid flows flow at least partially in counterflow to each other in the recuperator. As a result, the average temperature difference between both fluid flows is greater so that the transferred thermal output increases in comparison to cross-flow or parallel-flow guiding.

In a variant of the invention, the airflow flows in via axial inlets and/or flows out via axial outlets. The airflow preferably enters at an end side of the hollow cylindrical recuperator and exits the recuperator at the opposite end side.

The combustion airflow is preheated in the recuperator before it is fed to the combustion chamber. The combustion air is preferably compressed in advance by the compressor and is therefore pressurized when flowing through the recuperator.

Passages for the hot exhaust gas flow and passages for the airflow are arranged adjacent to each other in the recuperator. In this case, a passage for the exhaust gas flow and a passage for the airflow alternate in each case.

Adjacent passages are separated from each other by means of at least one wall. The wall can be a thin metal plate, for example.

By means of the walls, the passages are divided into channels which extend in the axial direction and are arranged along the circumference of the annular recuperator. In this case, a channel for the exhaust gas flow and a channel for the airflow alternate in each case along the circumference. The channels extend over the entire length of the recuperator.

The walls extend between an inner casing surface and an outer casing surface of the recuperator. The walls preferably have a curved shape so that evolvently formed channels are formed. The walls are oriented parallel to each other and are arranged along the circumference of the annular recuperator.

### BRIEF DESCRIPTION OF THE DRAWINGS

Further features and advantages of the invention come from the description of exemplary embodiments with reference to drawings and from the drawings themselves.

In the drawing:

FIG. 1 shows an axial section through a micro-gas turbine plant,

FIG. 2 shows a perspective view of the casing surfaces of the recuperator viewed from the air inlet side,

FIG. 3 shows a perspective view of the casing surfaces of the recuperator viewed from the air outlet side,

FIG. 4 shows an enlarged view of exhaust gas passages and air passages arranged in an alternating manner to each other,

FIG. 5 shows a shingle with an alternative variant of closing off the passages,

a as an axial front view,

b as a perspective view,

FIG. 6 shows a cassette with a plurality of shingles,

a as an axial front view,

b as a perspective view,

FIG. 7 shows a cassette with clamping plates,

a as an axial front view,

b as a view enlargement of the region A,

c as a perspective view,

FIG. 8 shows a cassette without clamping plates,

a as an axial front view,

b as a view enlargement of the region B,

c as a perspective view.

### DETAILED DESCRIPTION OF THE PREFERRED EMBODIMENTS

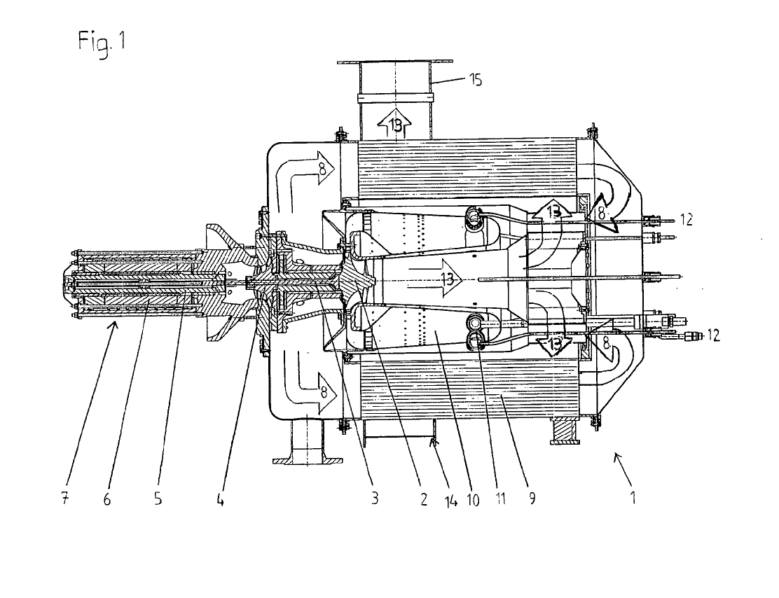

FIG. 1 shows a micro-gas turbine plant 1. The micro-gas turbine plant in the exemplary embodiment is 1.6 m long, 1.7 m wide, and has a diameter of 0.7 m and an electrical output of 100 kW. The micro-gas turbine plant 1 comprises a turbine 2 which drives a shaft 3. A compressor 4 and a rotor 5 are arranged on the shaft 3. The compressor 4 is a single-stage radial compressor. A single-stage radial turbine is used as the turbine 2. The rotor 5 is enclosed by a stator 6. Rotor 5 and stator 6 are component parts of a generator 7 which serves for power generation.

Air is inducted and compressed by the compressor 4. The airflow 8 flows axially into an annular recuperator 9 and flows out axially on the opposite side. In the recuperator 9, the airflow 8 is heated and flows to a combustion chamber 10. The combustion chamber 10 comprises burners 11 in which a fuel gas is combusted with the preheated air to form an exhaust gas. The fuel gas is directed via feeds 12 to the burners 11.

The exhaust gas flows via the turbine 2 and drives this. The expanded exhaust gas flow 13 flows radially into the recuperator 9, flows through the recuperator 9 in the axial direction and flows radially out of the recuperator 9. In the recuperator, the exhaust gas flow 13 yields heat to the intake airflow 8. The cooled exhaust flow 13 flows into an annular exhaust-gas collector 14 and exits the micro-gas turbine plant 1 through an exhaust-gas stack 15.

The recuperator 9 encloses the combustion chamber 10.

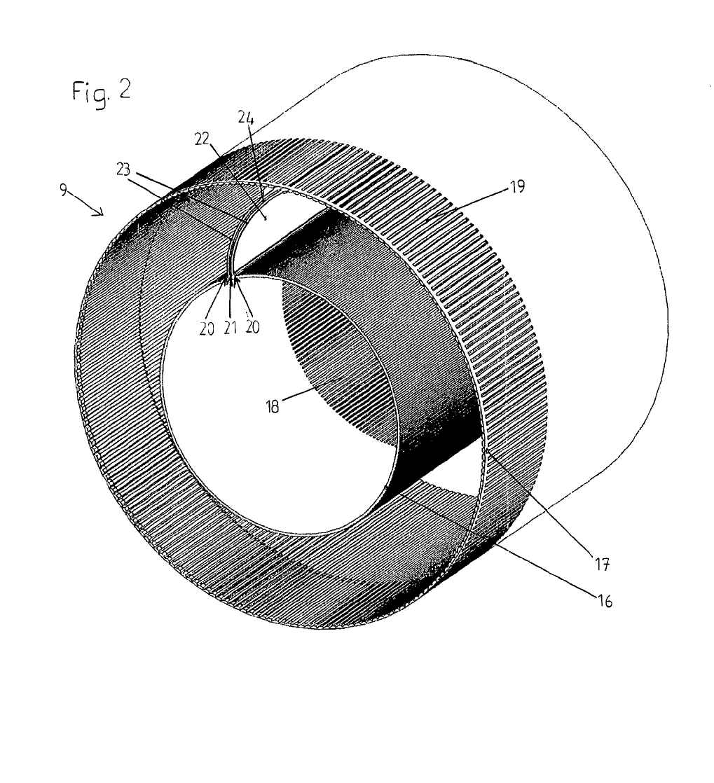

FIG. 2 shows a perspective view of the casing surfaces 16, 17 of a recuperator 9 viewed from the air inlet side. The casing surfaces 16, 17 are formed from two tubes.

The inner casing surface 16 has openings at one end. The openings are formed as longitudinal slots which extend in the axial direction. The openings form radial inner inlets 18 for the exhaust gas flow 13.

The outer casing surface 17 also has openings. The openings are formed as longitudinal slots which extend in the axial direction. The openings form radial outer outlets 19 for the exhaust gas flow 13.

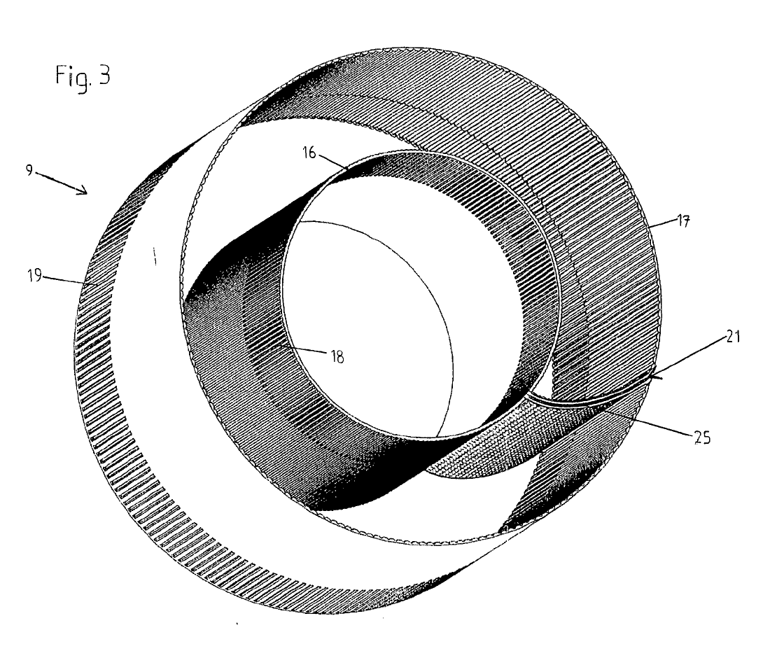

The recuperator 9 has passages 20 for the exhaust gas flow 13 and passages 21 for the airflow 8. The passages 20, 21 are arranged in an alternating manner to each other along the circumference of the annular recuperator 9. The passages 20, 21 fill out the entire space between the inner casing surface 16 and the outer casing surface 17 of the recuperator 9. In FIGS. 2 and 3, only three of these passages 20, 21 are drawn in by way of example.

The passages 20, 21 extend in an axial direction over the entire length of the casing surfaces 16. The passages 20, 21 are spatially separated from each other by means of walls 22 so that no intermixing of the airflow 8 and the exhaust gas flow 13 occurs.

The walls 22 have a curved shape and form evolvents which extend between the inner casing surface 16 and the outer casing surface 17. The walls 22 are arranged parallel to each other. All the walls 15 are metal foils. In the exemplary embodiment, the foils are formed of steel, preferably X6CrNiTi 18-10. They have a thickness of 0.125 mm.

The passages 20 for the exhaust gas flow 13 are closed off at the end sides of the recuperator 9 by cover elements 23. The cover elements 23 are metal sheets which also have a curved shape.

The passages 21 for the airflow 8 are open at the end sides of the recuperator 9. At the end side of the recuperator 9, shown in FIG. 2, the airflow 8 enters the recuperator 9 through axial inlets 24, flows through the passages 21 in the axial direction and exits the recuperator 9 through axial outlets 25 (shown in FIG. 3) at the opposite end side of the recuperator 9.

The hot exhaust gas flow 13 enters the passages 20 through the radial inner inlets 18, flows through these in the axial direction and exits the passages 20 through the radial outer outlets 19. The exhaust gas flow 13 which discharges from the radial outer outlets 19 flows into the annular exhaust gas collector 14 (according to FIG. 1) and exits the micro-gas turbine plant 1 through the exhaust-gas stack 15.

FIG. 3 shows a perspective view of the casing surfaces 16, 17 of the recuperator 9 viewed from the air outlet side. The airflow 8 exits the passages 21 via the axial outlets 25. In the recuperator 9, the airflow 8 and the exhaust gas flow 13 flow at least partially in counterflow to each other. The radial inner inlets 18 and the radial outer outlets 19 are arranged on sides of the recuperator 9 which lie axially opposite each other.

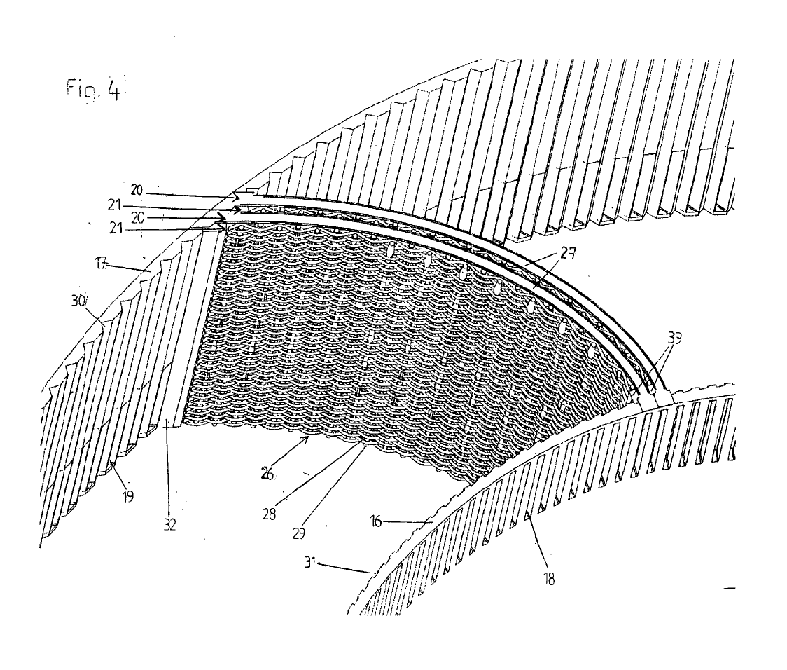

FIG. 4 shows a detail for the annular recuperator with passages 20 for the exhaust gas flow 13 and passages 21 for the airflow 8. In FIG. 4, for reasons of clarity, only four passages 20, 21 are shown by way of example. The passages are arranged in an alternating manner to each other. They fill out the entire space of the recuperator between the inner casing surface 16 and the outer casing surface 17. In the exemplary embodiment, the inner casing surface 16 is formed from an inner tube and the outer casing surface 17 is formed from an outer tube.

In the exemplary embodiment, fillers 26 are arranged in each passage 20 for the hot exhaust gas flow 13 and in each passage for the airflow 8. The fillers 26 for the hot exhaust gas flow are concealed by covers 27 and are therefore not visible in the view according to FIG. 4. The covers 27 close off the passages 20 of the exhaust gas flow 13 at the front and rear end sides of the recuperator. The covers 27 also have a curved shape and are welded to the walls 22.

The fillers 26 consist of a wire arrangement. This wire arrangement is constructed as a wire mesh in which wires 28 which extend in the radial direction are guided in an alternating manner over and under wires 29 which extend in the axial direction.

The outer tube has grooves 30 which on its inner side extend in the axial direction. The inner tube has grooves 31 which on its outer side extend in the axial direction.

In the passages 21 for the airflow 8, strips 32 are arranged between the grooves 30 of the outer tube and the filler 26. The strips 32 partially engage in the grooves 30 and support the filler 26. Furthermore, in the passages 21 for the airflow 8, strips 33 are arranged between the grooves 31 of the inner tube and the fillers 26. The strips 32 partially engage in the grooves 31 and support the fillers 26.

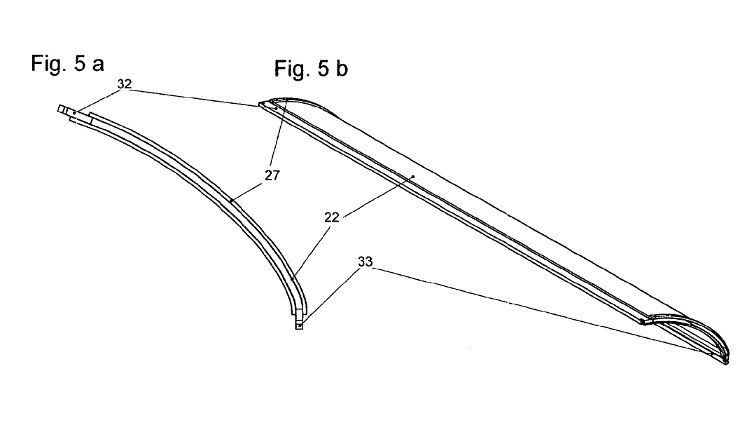

FIGS. 5 a and 5 b show a shingle of the recuperator 9. A shingle is a sub-assembly of the recuperator 9. The recuperator 9 is preferably constructed from a multiplicity of shingles, preferably from more than one hundred and twenty, especially from more than one hundred and fifty shingles. In the exemplary embodiment, the recuperator 9 is constructed from one hundred and eighty five shingles.

FIGS. 5 a and 5 b show an alternative construction of such a shingle. Covers 27 are welded to the walls 22 which are constructed as metal foils. In the production of the individual shingles, covers 27 are first of all welded onto the exhaust-gas side of walls 22 axially at the front and axially at the rear. For forming a shingle, a strip 32 is inserted radially on the outside and a strip 33 is inserted radially on the inside between two walls 22 in each case.

In this case, strips can also alternatively be used as covers 27, wherein these preferably have a rectangular or square profile so that the covers 27 are formed as elongated cuboid metal bodies which are preferably positioned on one longitudinal side on a wall 22 and welded to this.

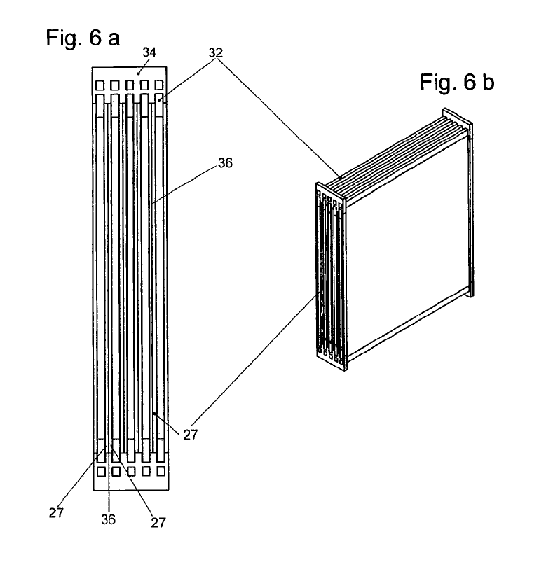

FIGS. 6 a and 6 b show a cassette. In the view, only an exemplary number of shingles is shown. For reasons of clarity, the figures show shingles without a curved shape. A cassette is a module of the recuperator 9. These cassettes are compact sub-assemblies from which the recuperator 9 can be assembled. The recuperator 9 preferably consists of more than five such modules and less than ten such modules. Each module preferably consists of more than ten and less than forty such shingles, especially more than fifteen and less than thirty five shingles. A comb 34 serves for the fixing and/or connecting of the individual elements. The metal comb 34 is preferably welded to adjoining elements.

For closing off a passage 20 of the exhaust gas flow 13 on the end sides of the recuperator 9, a plurality of covers 27, which are interconnected, can also be used. Adjoining covers are preferably welded to each other.

For producing the recuperator 9, it proves to be favorable in this case if covers 27 are first of all welded onto two walls 22. The two walls 22 with their covers 27 are then aligned with each other. At the place where adjacent covers 27 meet each other, these are welded to each other. In this case, a welded seam 36, which extends between the two covers 27, is formed. The welded seam 36 extends between the adjacent covers 27 in the radial direction on the end sides of the recuperator 9. In this case, two inter-welded covers 27 always close off a passage 20 of the exhaust gas flow 13. The passages 21 for the compressed airflow 8 are open at the end sides of the recuperator 9.

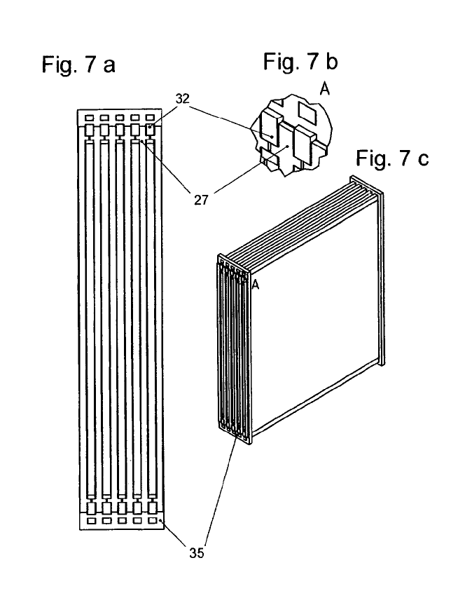

FIGS. 7 a, 7 b and 7 c show a variant with clamping plates as covers 27. For reasons of clarity, the figures show shingles without a curved shape. A mirror plate 35 serves for the fixing and/or connecting of the individual elements. The metal mirror plate 35 is preferably welded to the adjacent elements.

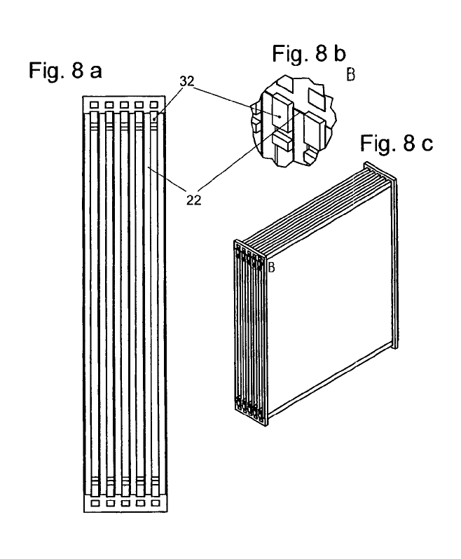

FIGS. 8 a, 8 b and 8 c show a variant without clamping plates, wherein the walls 22, formed as metal foils, are flanged. For reasons of clarity, the figures show shingles without a curved shape. A cover 27 is first of all welded to one wall 22. A wall 22 of the adjacent shingle is flanged onto the cover 27.

Laser welding is especially suitable as the welding method.

1. A micro-gas turbine plant (1) comprising an annular recuperator (9) for heat transfer from an exhaust gas flow (13) to an airflow (8),
the recuperator (9) includes at least one of radial inlets (18) or radial outlets (19), and the exhaust gas flow is through the at least one of the radial inlets or the radial outlets.

2. The micro-gas turbine plant as claimed in claim 1, wherein the recuperator includes both the radial inlets (18) and the radial outlets (19) which are arranged on sides of the recuperator (9) which lie axially opposite each other.

3. The micro-gas turbine plant as claimed in claim 1, wherein the recuperator (9) has at last one of an inner casing surface (16) or an outer casing surface (17).

4. The micro-gas turbine plant as claimed in claim 3, wherein the at least one of the inner casing surface (16) or the outer casing surface (17) have, or has, openings which form at least one of the radial inlets (18) or the radial outlets (19) for the exhaust gas flow (13).

5. The micro-gas turbine plant as claimed in claim 3, wherein the at least one of the inner casing surface (16) or the outer casing surface (17) are, or is, formed from a bent metal strip.

6. The micro-gas turbine plant as claimed in claim 3, wherein the at least one of the inner casing surface (16) or the outer casing surface (17) are, or is, formed from a tube.

7. The micro-gas turbine plant as claimed in claim 3, wherein the at least one of the inner casing surface (16) or the outer casing surface (17) extend, or extends, over an entire length of the recuperator (9) in an axial direction.

8. The micro-gas turbine plant as claimed in claim 3, wherein the outer casing surface (17) extends as far as an exhaust gas collector (14) in an axial direction.

9. The micro-gas turbine plant as claimed in claim 1, further comprises at least one of axial inlets or axial outlets, wherein the airflow (8) flows into the recuperator (9) via at least one of the axial inlets (24) or flows out of the recuperator (9) via the axial outlets (25).

10. The micro-gas turbine plant as claimed in claim 1, wherein the exhaust gas flow (13) and the airflow (8) are conducted at least partially in counterflow to each other in the recuperator (9).

11. The micro-gas turbine plant as claimed in claim 1, wherein passages (20) for the exhaust gas flow (13) and passages (21) for the airflow (8) are arranged in an alternating manner to each other in the recuperator (9) and are separated from each other in each case by at least one wall (22).

12. The micro-gas turbine plant as claimed in claim 11, wherein the walls (22) extend between an inner casing surface (16) and an outer casing surface (17).

13. The micro-gas turbine plant as claimed in claim 11, wherein the walls (22) have a curved shape and are arranged parallel to each other along a circumference of the annular recuperator (9).
